(19) United States
(12) Patent Application Publication
(10) Pub. No.: US 2026/0002825 A1
(43) Pub. Date: Jan. 1, 2026

(54) SENSOR WITH MICROSTRUCTURE

(71) Applicant: INNOVATIONLAB GMBH, Heidelberg (DE)

(72) Inventor: Johannes Zimmermann, Heidelberg (DE)

(21) Appl. No.: 18/881,078

(22) PCT Filed: Jul. 7, 2023
(86) PCT No.: PCT/EP2023/068907

§ 371 Date: Jan. 3, 2025

(30) Foreign Application Priority Data
Jul. 7, 2022 (LU) 502480

(51) Int. Cl. G01L 1/22; H01C 17/065

(52) U.S. Cl. CPC G01L 1/2287; G01L 1/2268; H01C 17/065

(57) ABSTRACT

A force sensor (10) and a method for measuring a force are disclosed. The force sensor (10) comprises a first non-conductive substrate (1) and a second non-conductive substrate (4). A first electrode (2a) and a second electrode (2b) are disposed on the first substrate (1) and offset to each other. A first conductive layer (3) is disposed on the first substrate (1) and is conductively connecting the first electrode (2a) and the second electrode (2b) with a first layer resistance (R1). A second conductive layer (5) is disposed on the second substrate (4). The second conductive layer (5) is configured to conductively connect the first electrode (2a) and the second electrode (2b) via the second conductive layer (5) with a second layer resistance (R2) when the first non-conductive substrate (1) and the second non-conductive substrate (4) approach each other.

### BACKGROUND OF THE INVENTION

### Field of the Invention

The field of the invention relates to a force sensor, a method for measuring a force with the force sensor, a method for calibrating the force sensor, and a method for manufacturing the force sensor.

### Brief Description of the Related Art

Sensors manufactured using a printing process have numerous advantages over conventional sensor technologies, such as semiconductor-based sensors. Printed sensors can be manufactured using a variety of materials, including flexible or biodegradable materials. Manufacturing effort and time for the printed sensors can furthermore be decreased significantly compared to conventional manufacturing processors, and the printed sensors are thinner and weigh less than prior art sensors. Despite these advantages, the printed sensors are reaching their limit in many applications due to insufficient quality of the measurement values. It is therefore desired to improve the measurement quality of the printed sensors to further enhance the potential of this technology.

In the field of printed piezoresistive sensors or FSR (force-sensitive-resistor), two basic sensor types can be distinguished. With the Thru-mode sensor, two electrodes, usually coated with carbon, are pressed together by an external force. The contact between the two electrodes improves and the resistance decreases, as the force increases. With the shunt-mode sensor, the two electrodes are fabricated side by side on the same substrate. An electrically conductive material applied to a different substrate is pressed against the two electrodes in such a way that the two electrodes are short-circuited. The electrical contact between the materials changes, reducing the resistance, as the force increases.

These two concepts have been the basis of all fully printed piezoresistive sensors to date. In general, the resistance of the sensors depends not only on the external force, but also on the ambient temperature and humidity. Material fatigue further changes the resistance over time. The sensors must therefore be calibrated several times depending on the application, but at least once at the beginning of the measurement.

The printed sensors have, however, a number of disadvantages:

a) Calibration of the sensors is difficult to perform. Both the Thru and Shunt mode sensors have in common that they have an infinitely large (non-measurable) electrical resistance in the absence of an external force. The sensors can thus only be calibrated if a sufficiently large force is applied to the sensors. This is disadvantageous in several respects: the field of application of the printed sensors for measuring force is usually implemented in large-area sensor matrices and sensor arrays for measuring pressure distribution, rather than using individual ones of the printed sensors. To calibrate such sensor matrices, it is necessary to develop appropriate calibration equipment that loads the area of the entire area of the sensor matrix in a controlled manner. Calibration against a defined pressure load is often difficult to perform after the printed sensors have been mounted for use in the sensor matrix.

b) Time drift, hysteresis and resolution are worse compared to the conventional sensors: Inks are used to manufacture the printed sensors. These inks contain polymers that deform plastically and viscoelastically under the influence of force. The time drift, hysteresis, and resolution of the printed sensors are consequently worse than those of competing strain gauges, which are applied to stiff materials and thus exhibit almost purely elastic compression-deformation behavior.

Several publications and patents have shown that microstructuring of the interfaces can significantly improve these properties. See, for example, Shi, Xinlei, et al. “Bioinspired ultrasensitive and stretchable MXene-based strain sensor via nacre-mimetic microscale “brick-and-mortar” architecture.” ACS nano 13.1 (2018): 649-659: Xia, Tiancheng, et al. “Ultrahigh sensitivity flexible pressure sensors based on 3d-printed hollow microstructures for electronic skins.” Advanced Materials Technologies 6.3 (2021): 2000984. Park, Jonghwa, et al. “Tactile-direction-sensitive and stretchable electronic skins based on humanskin-inspired interlocked microstructures.” ACS nano 8.12 (2014): 12020-12029: Wan, Yongbiao, Yan Wang, and Chuan Fei Guo. “Recent progresses on flexible tactile sensors.” materials today physics 1 (2017): 61-73: Lee, Da-Huei, et al. “Flexible Piezoresistive Tactile Sensor Based on Polymeric Nanocomposites with Grid-Type Microstructure.” Micromachines 12.4 (2021): 452; and Park, Jonghwa, et al. “Tailoring force sensitivity and selectivity by microstructure engineering of multidirectional electronic skins.” NPG Asia Materials 10.4 (2018): 163-176.

Such microstructures generally, however, cannot be manufactured using low-cost fabrication methods that can be scaled to large production throughputs. The microstructure is mostly achieved by imprinting with a mask or stamp and is not generally transferable to all inks and materials, but requires special material properties, such as thermoplastic deformation. These properties are not present in commercially available inks. Furthermore, the stamping-in of a structure is very time-consuming and therefore not compatible with the cost-efficient production of printed electronics.

A number of patent applications are known which address the application of microstructures to sensors. International patent application WO 2018 120384 A1 describes a pressure sensor that comprises two external connection electrodes and two oppositely provided elastic substrates. A contact surface of at least one of the elastic substrates is provided with protrusion structures. The contact surfaces are defined as the surfaces of the two elastic substrates that are disposed opposite to each other. The elastic substrates are conductors and each of the elastic substrates is connected to an external connection electrode. The surfaces of the protrusion structures are covered with conductive layers.

Korean patent KR 101878358 B1 describes a pressure sensor which comprises two opposing substrates. Each substrate can have a microstructured surface. The substrates are coated with a conductive layer which in turn are each connected to an electrode.

European patent application EP 1525527 A1 describes resistive touch sensors that incorporate microstructured conductive layers. When local electrical contact is made between the microstructured conductive layer and an opposing conductive layer due to a touch input, the resulting signal can be used to determine the location of the touch.

U.S. Pat. No. 8,877,538 B2 describes a pressure sensor having a nanostructure and a method for manufacturing the same. More particularly, this US patent relates to a pressure sensor having a nanostructure attached on the surface of the pressure sensor and thus having improved sensor response time and sensitivity and a method for manufacturing the same. The pressure sensor has a nanostructure includes a substrate, a source electrode and a drain electrode arranged on the substrate with a predetermined spacing, a flexible sensor layer disposed on the source electrode and the drain electrode, and a nanostructure attached on the surface of the flexible sensor layer and having nanosized wrinkles.

Chinese patent application CN 105203244 A describes an electronic skin with irregular surface microspikes. The electronic skin comprises a substrate, a support layer, a pressure-sensitive sensing layer, an electrode layers and a flexible protective layer in sequence from bottom to top. The edge of the flexible protective layer is bonded with the substrate through a double-side viscous layer, so as to package the support layer, the pressure-sensitive sensing layer, and the electrode layer. The microspikes are formed on the surfaces of both the support layer and the pressure-sensitive sensing layer.

### SUMMARY OF THE INVENTION

This document discloses a printed force sensor that can be calibrated easily and without applying a reference force, while offering advantages of a microstructured contact surface in terms of sensitivity, resolution drift and hysteresis. A method for measuring a force with the force sensor, a method for calibrating the force sensor, and a method for manufacturing the force sensor are further described.

According to a first aspect of the invention, the force sensor comprises a first nonconductive substrate and a second non-conductive substrate, a first electrode and a second electrode. The first electrode and the second electrode are disposed on the first substrate and are offset to each other. The force sensor further comprises a first conductive layer, disposed on the first substrate and conductively connecting the first electrode and the second electrode with a first layer resistance. The force sensor further comprises a second conductive layer, disposed on the second substrate, the second conductive layer configured to conductively connect the first electrode and the second electrode via the second conductive layer with a second layer resistance when the first non-conductive substrate and the second non-conductive substrate approach each other.

The first conductive layer can cover at least a part of the first electrode and at least a part of the second electrode and the surface of the first conductive layer can have a microstructure.

The first electrode and the second electrode can have an interdigital finger structure and the first non-conductive substrate, and the second non-conductive substrate can be the same substrate.

A method for measuring a force with a force sensor is further described. The force sensor comprises a first electrode and a second electrode offset to the first electrode, a first conductive layer conductively connecting the first electrode and the second electrode with a first layer resistance, and a second conductive layer. The method comprises the steps of applying the force to the force sensor, determining a resistance of the force sensor between the first electrode and the second electrode, and determining the force from the resistance, the first layer resistance and the second layer resistance.

The step of determining the resistance can comprise the steps of applying a voltage between the first electrode and the second electrode and measuring a current between the first electrode and the second electrode.

A method for calibrating the force sensor is further described. The method comprising the steps of determining the first layer resistance of the first conductive layer and correcting a measurement value of a force applied to the force sensor based on the determined first layer resistance.

A method for manufacturing a force sensor is further described. The method comprises the steps of providing a first non-conductive substrate with a first electrode and a second electrode offset to the first electrode. The method further comprises creating a first conductive layer on the first non-conductive substrate, such that the first conductive layer conductively connects the first electrode and the second electrode, and a surface of the first conductive layer has a microstructure. The method further comprises providing a second non-conductive substrate with a second conductive layer.

Creating the first conductive layer can comprise a printing process.

The method for manufacturing a force sensor can further comprise the step of positioning the first non-conductive substrate and the second non-conductive substrate.

The first electrode and the second electrode can be applied to the first non-conductive substrate with a printing process and the second conductive layer can be applied to the second non-conductive substrate with a printing process.

### DESCRIPTION OF THE FIGURES

FIG. 1 shows a cross-sectional view of a first aspect of a force sensor.

FIG. 2 shows another view of a first aspect of the force sensor.

FIG. 3 shows an electric block diagram of the first aspect of the force sensor.

FIG. 4 shows a cross-sectional view of a second aspect of the force sensor.

FIG. 5 shows the surface microstructure of the first aspect of the force sensor.

FIG. 6 shows a diagram of the sensitivity of different force sensors.

FIG. 7 shows a flow chart describing a method for measuring a force with the force sensor.

FIG. 8 shows a flow chart describing a method for calibrating the force sensor.

FIG. 9 shows a flow chart describing a method for manufacturing the force sensor.

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

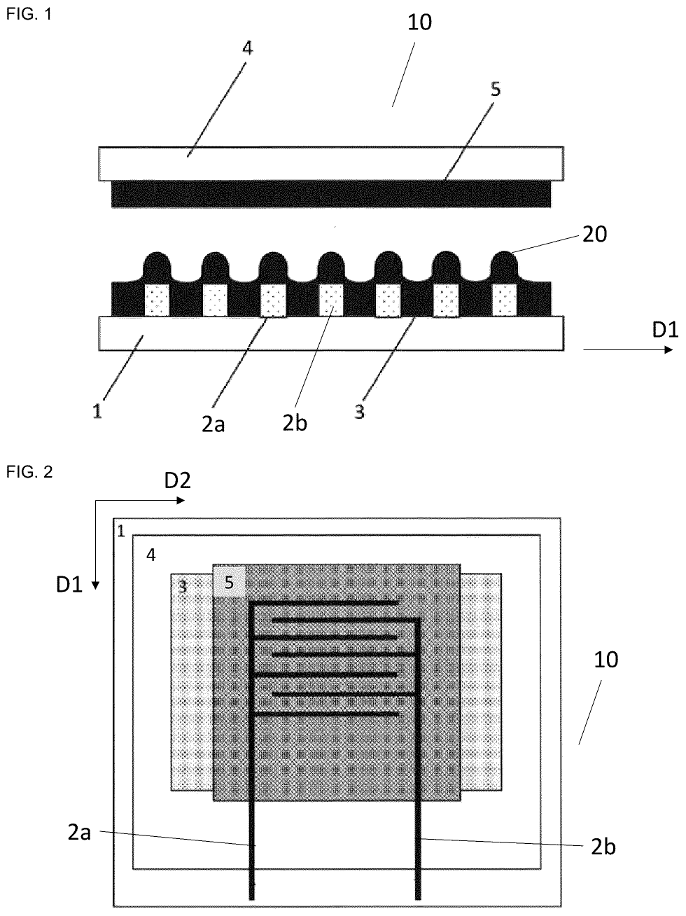

FIG. 1 shows a cross-sectional view of a first aspect of a force sensor 10. The force sensor 10 is termed a parallel-mode-sensor. A first non-conductive substrate 1 forms the base for the lower part of the force sensor 10. The thickness of the first non-conductive substrate 1 can be in the range of from 5 μm to 500 μm, and in one aspect in the range of from 50 μm to 200 μm, but this range is not limiting for the invention. The first non-conductive substrate 1 can comprise a single layer only or multiple layers made of different materials in the form of a substrate laminate. The first non-conductive substrate 1 extends in a plane that is defined by a first direction D1 and a second direction D2 (see FIG. 2).

The first non-conductive substrate 1 is made from a non-conductive material that can be printed such as a polymer. The first non-conductive substrate 1 may, for example, be made from a polymer such as but not limited to poly(ethyleneterephthalate) (PET), poly(ethylenenaphthalate) (PEN), polyimide (PI), thermoplastic polyurethane (TPU), poly(dimethylsiloxane) (PDMS). Further suitable examples for substrate materials are paper and cardboard. Glass, silicone based substrates, woven fabrics, nonwoven fabrics, nonwoven mats, fiber mats and plies, in particular glass fiber mats and plies may alternatively be used as a material for the first non-conductive substrate 1. Suitable fiber mats and plies include in particular fiber mats and plies which are used for producing fiber reinforced composite materials. Suitable fabrics include, for example, cotton or polymer based woven and nonwoven fabrics.

In one aspect of the invention, the first non-conductive substrate I is a flexible foil made of polymer or metal, which can be used in a printing process, such as but not limited to a roll-to-roll process. The first non-conductive substrate I can be coated with a dielectric layer, in case the first non-conductive substrate 1 is made of metal.

A first electrode 2a and a second electrode 2b are arranged on a surface of the first non-conductive substrate 1. The first electrode 2a and the second electrode 2b are offset to each other and do not touch each other. The first electrode 2a and the second electrode 2b have an interdigital finger structure (as explained with respect to FIG. 2) but can alternatively have any other structure. The first electrode 2a and the second electrode 2b have a rectangular cross-section but can also have an alternative cross-sectional shape.

The first electrode 2a and the second electrode 2b are made from silver-containing material or other kinds of conductive material. Examples of further kinds of materials include, but are not limited to, copper or gold as well as alloys thereof and carbon-containing composite materials. Using a material with high electrical conductivity allows electrical current to flow through the first electrode 2a and the second electrode 2b. The first electrode 2a and the second electrode 2b can alternatively be made from different materials.

A first conductive layer 3 is arranged on the first non-conductive substrate 1 and on the first electrode 2a and the second electrode 2b. The first conductive layer 3 is in contact with the first electrode 2a, the second electrode 2b and the first non-conductive substrate 1. The first conductive layer 3 covers the surface of the first non-conductive substrate 1 which is located between the first electrode 2a and the second electrode 2b. The first conductive layer 3 further covers the whole surface of the first electrode 2a and the second electrode 2b which is not in contact with the first non-conductive substrate 1. The sensitivity of the force sensor 1 is enhanced if the contact surface between the first conductive layer 3 and the first electrode 2a and the second electrode 2b is maximized.

The first conductive layer 3 further has a microstructured surface 20. The microstructure corresponds to the structure of the first electrode 2a and the second electrode 2b which emerges on the surface 20 of the first conductive layer 3. The microstructure can alternatively have a structure that does not only correspond to the structure of the first electrode 2a and the second electrode 2b but can also be influenced by the manufacturing process of the first conductive layer 3. The surface 20 of the first conductive layer 3 extends in a plane which is parallel to the first non-conductive substrate 1.

The first conductive layer 3 is made from a conductive material. Examples of materials include, but are not limited to, silver-containing material, copper, or gold as well as alloys thereof and carbon-containing composite materials. The first conductive layer 3 has a constant first layer resistance R₁ which is dependent from the material of the first conductive layer 3.

The first conductive layer 3 electrically connects the first electrode 2a and the second electrode 2b such that a finite electrical resistance between the first electrode 2a and the second electrode 2b can be set. This resistance can be set via the choice of the material of the first electrode 2a and the second electrode 2b, the thickness and the geometry of the structure of the first electrode 2a and the second electrode 2b as well as the material and the thickness and geometry of the first conductive layer 3.

The first non-conductive substrate 1, the first electrode 2a, the second electrode 2b and the first conductive layer 3 form the lower part of the force sensor 1. A second nonconductive substrate 4 forms the base of the upper part of the force sensor 1. The second non-conductive substrate 4 is arranged substantially parallel to the first non-conductive substrate 1.

The thickness of the second non-conductive substrate 4 can be in the range of from 5 μm to 500 μm, for example in the range of from 50 μm to 200 μm, but this is not limiting for the invention. The second non-conductive substrate 4 can comprise a single layer only or multiple layers made of different materials in the form of a substrate laminate.

The second non-conductive substrate 4 is made from the same material as described for the first non-conductive substrate 1 but can alternatively be made from a different material than the first non-conductive substrate 1.

A second conductive layer 5 is arranged on the second non-conductive substrate 4. The second conductive layer 5 covers parts of the surface of the second non-conductive substrate 4. The second conductive layer 5 has an even surface which is substantially parallel to the first non-conductive substrate 1, the second non-conductive substrate 4 and the direction of extension of the surface 20 of the first conductive layer 3. The second conductive layer 5 can alternatively have a microstructured surface.

The second conductive layer 5 is made from a conductive material. Examples of materials include, but are not limited to, silver-containing material, copper, or gold as well as alloys thereof and carbon-containing composite materials. The second conductive layer 5 has a constant second layer resistance R₂ which is dependent from the material of the second conductive layer 5. The materials of the first conductive layer 3 and the second conductive layer 5 can be chosen such that the second layer resistance R₂ is smaller than the first layer resistance R₁. This enhances the sensitivity of the force sensor 10.

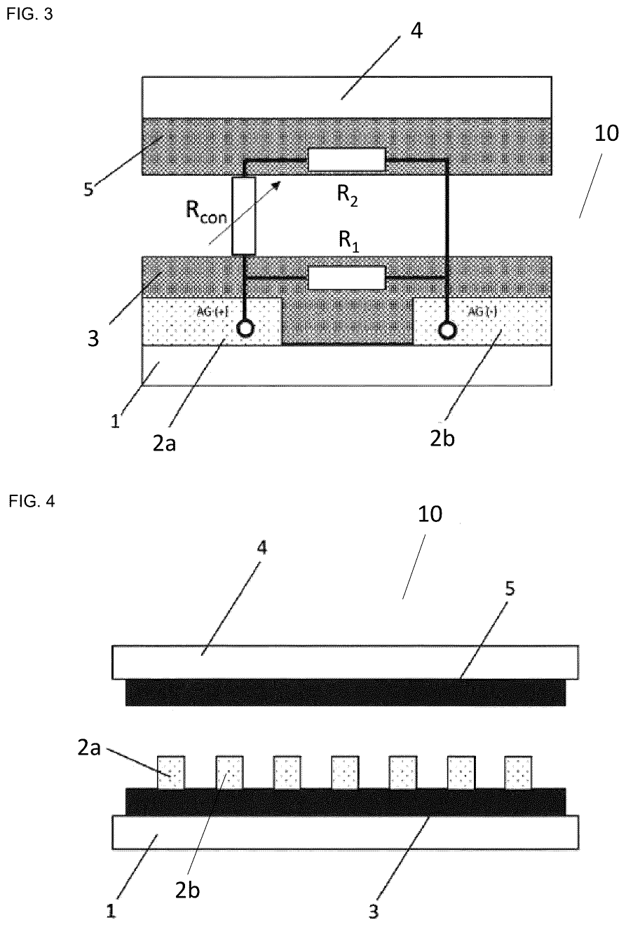

The functioning of the sensor is described with respect to FIG. 3.

FIG. 2 shows another view of a first aspect of the force sensor 10. The first nonconductive substrate 1 has a plate-shaped form with a spread in two spatial dimensions (i.e., in the first direction D1 and the second direction D2 in a plane). This spread is substantially larger than in the third spatial dimension, for example in a normal to the plane. The first nonconductive substrate I can alternatively have different forms and the rectangular form shown in FIG. 2 is not limiting of the invention.

The second non-conductive substrate 4 also has a plate-shaped form with a spread in two spatial dimensions (i.e., in the first direction D1 and the second direction D2 in a plane). This spread is substantially larger than in the third spatial dimension, for example in a normal to the plane. The second non-conductive substrate 4 can alternatively have different forms and the rectangular form shown in FIG. 2 is not limiting of the invention.

The first conductive layer 3 has a plate-shaped form with a spread in two spatial dimensions (i.e., in the first direction D1 and the second direction D2 in a plane). This spread is substantially larger than in the third spatial dimension, for example in a normal to the plane. The first conductive layer 3 can alternatively have different forms and the rectangular form shown in FIG. 2 is not limiting of the invention.

The second conductive layer 5 has a plate-shaped form with a spread in two spatial dimensions (i.e., in the first direction D1 and the second direction D2 in a plane). This spread is substantially larger than in the third spatial dimension, for example in a normal to the plane. The second conductive layer 5 can alternatively have different forms and the rectangular form shown in FIG. 2 is not limiting of the invention.

At least parts of the first non-conductive substrate 1, the second non-conductive substrate 4, the first conductive layer 3 and the second conductive layer 5 overlap each other. The first electrode 2a and the second electrode 2b have an interdigital finger structure with each having a plurality of fingers. The fingers of the first electrode 2a and the second electrode 2a are arranged alternately but can also be arranged in a different manner. Arranging the plurality of fingers of the first electrode 2a and the second electrode 2b in an alternating manner allows to enlarge the area on which the force sensor 10 can measure the force applied to the force sensor 10. The quantity and dimension of the fingers of the first electrode 2a and the second electrode 2b are illustrated as an example and are not subject to any restrictions.

FIG. 3 shows an electric block diagram of the first aspect of the force sensor 10. State-of-the-art printed sensors have an infinitely large resistance in a state in which the sensor is unloaded. The present force sensor 10, in contrast, has a finite resistance R in a state in which the force sensor 10 is unloaded. The structure of the force sensor 10 leads to a parallel circuit with the finite resistance in the unloaded state. The resistance R of the force sensor 10 between the first electrode 2a and the second electrode 2b is calculated as follows:

$$R ( F ) = {( \frac{1}{{R}_{c o n} ( F ) + {R}_{2}} + \frac{1}{{R}_{1}} )}^{- 1}$$

R_{con} is a contact resistance between the first conductive layer 3 and the second conductive layer 5. R_{con} is not a constant resistance but is dependent from the force F that is applied to the force sensor 10. R_{con} is infinitely large in a state in which the force sensor 10 is unloaded, as in this case there is no contact between the first conductive layer 3 and the second conductive layer 5. The resistance R of the force sensor 10 therefore equals the first layer resistance R₁ if no force F is applied to the force sensor 10.

The first conductive layer 3 and the second conductive layer 5 move towards each other and come into contact if the force F is applied to the force sensor 10 in a direction substantially normal to a plane defined by the first direction D1 and the second direction D2. R_{con} becomes a finite value as soon as the first conductive layer 3 and the second conductive layer 5 are in contact. This results in a change of the resistance R from which the value of the applied force F can be derived. The higher the force F that presses the first conductive layer 3 and the second conductive layer 5 together, the lower the contact resistance R_{con} becomes and the lower the resistance R of the force sensor 10 becomes. A measurement curve for the relation between the force F and the resistance R can be determined from experimental measurements.

The finite and constant first layer resistance R₁ can be used to test if the force sensor 10 is functional or if there is a malfunction such as an unintentional interruption of any electrical leads within or for connecting the force sensor 10. The force sensor 10 can be continuously tested for operability in an unloaded condition. This is not possible with state of the art sensors that have no finite resistance in the unloaded state.

The constant first layer resistance R₁ which is the maximum value of the resistance R of the force sensor 10 can further be used as a reference for calibrating the force sensor 10 also in the unloaded state. A change of R₁ over time can indicate aging processes, manufacturing fluctuations and other influences and can be used to compensate for these changes. The calibration of the force sensor 10 is further described with FIG. 8.

FIG. 4 shows a cross-sectional view of a second aspect of the force sensor 10. A first non-conductive substrate 1, a second non-conductive substrate 4 as well as a second conductive layer 5 are the same as described with FIG. 1 and will not be described in further detail. A first conductive layer 3 is, in contrast to the first aspect of the invention according to FIG. 1, arranged between the first non-conductive substrate 1 and a first electrode 2a and a second electrode 2b. The first electrode 2a and the second electrode 2b are applied to the first conductive layer 3 and have no direct contact with the first non-conductive substrate 1. The first electrode 2a and the second electrode 2b have the same structure and dimensions as described with FIG. 1.

The first electrode 2a and the second electrode 2a and the second conductive layer 5 move towards each other and come into contact if the force F is applied to the force sensor 10 in a direction substantially normal to a plane defined by the first direction D1 and the second direction D2. R_{con} is a contact resistance between the first electrode 2a and the second electrode 2b and the second conductive layer 5 in the case of this aspect of the invention. The higher the force F which presses the first electrode 2a and the second electrode 2b and the second conductive layer 5 together, the lower the contact resistance R_{con} becomes and the lower the resistance R of the force sensor 10 becomes. Furthermore, the previous explanations for determining the resistance R of the force sensor 10 and the force F remain valid for this aspect of the invention.

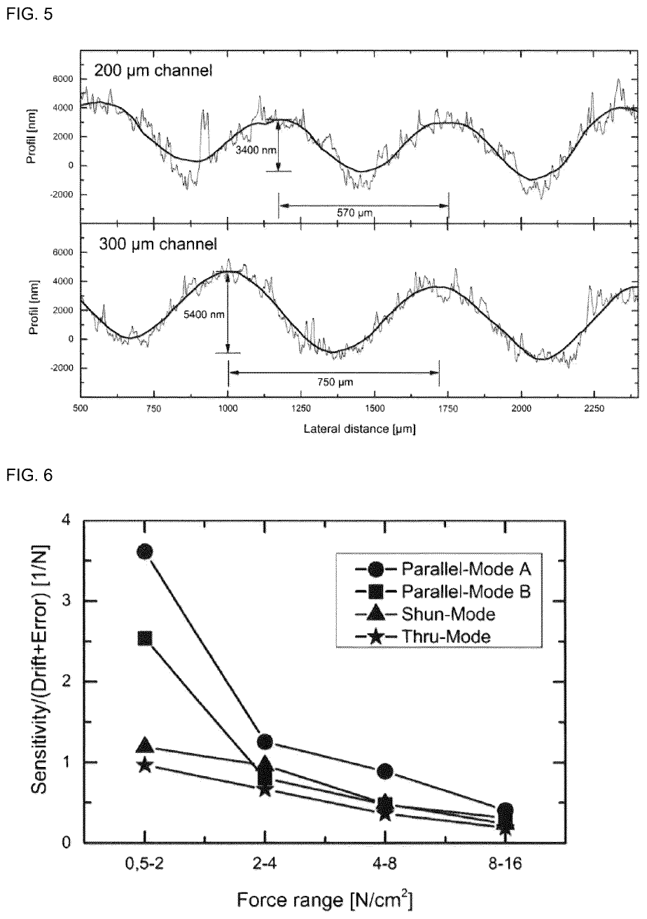

FIG. 5 shows a measurement of the surface microstructure of the first aspect of the force sensor 10. The surface 20 of the first conductive layer 3 has a wavelike profile which was generated by printing the first conductive layer 3 over the first electrode 2a and the second electrode 2a. The structure of the surface 20 can be changed by altering the distance between adjacent ones of the fingers of the first electrode 2a and the second electrode 2b. A distance of 200 μm between adjacent ones of the fingers of the first electrode 2a and the second electrode 2b was used to generate the profile of the surface 20 shown in the upper part of FIG. 5, whereas a distance of 300 μm was used in case of the lower part of FIG. 5. A larger distance between adjacent ones of the fingers of the first electrode 2a and the second electrode 2b leads to an increase in height and distance of the peaks of the wavelike structure of the surface 20. The structure of the surface 20 can be specifically adjusted by variation of the distance between adjacent ones of the fingers of the first electrode 2a and the second electrode 2b. Parameters of the force sensor 10 such as sensitivity, drift, hysteresis, and resolution, can hereby be adjusted.

FIG. 6 shows a diagram of the sensitivity of different force sensors. The advantages of the microstructure of the surface 20 can be seen in FIG. 6. The resolution of the force sensor 10 according to the invention (parallel-mode-sensor) Parallel-Mode A (corresponding to the first aspect of the invention according to FIG. 1) and Parallel-Mode B (corresponding to the second aspect of the invention according to FIG. 4) is better than in comparable shunt mode and thru mode sensors.

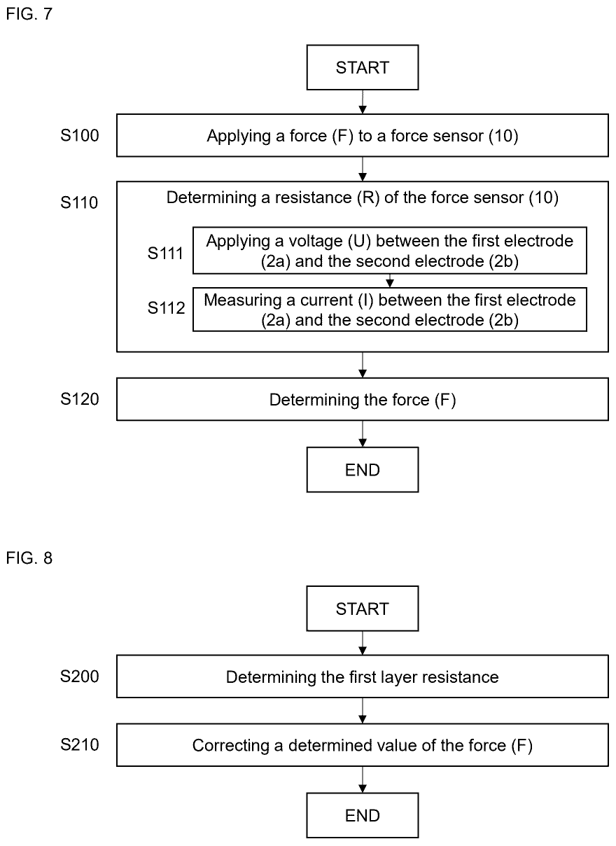

FIG. 7 shows a flow chart describing a method for measuring the force F applied to the force sensor 10. The force F needs to be applied in a direction substantially normal to a plane defined by a first direction D1 and a second direction D2 to obtain reliable and comparable measurement results.

A resistance R of the force sensor 10 is determined in a step S110 while the force F is applied to the force sensor 10. A known voltage U is applied between a first electrode 2a and a second electrode 2b in a step S111. A resulting current I is measured between the first electrode 2a and the second electrode 2b in a step S112. The resistance R is subsequently calculated from the voltage U and the current I using Ohm's law. The resistance R can alternatively be determined by any other method of determining the resistance R between the first electrode 2a and the second electrode 2b, such as determining the resistance R with a constant current.

The force F is determined from the determined resistance R in a step S120 using a measurement curve that depicts a known relation between the force F and the resistance R which can be determined from experimental measurements.

FIG. 8 shows a flow chart describing a method for calibrating the force sensor 10. The resistance R of the force sensor 10 is equal to the first layer resistance R₁ as described above. The first layer resistance R₁ is independent from the force F and can be measured in an unloaded state of the force sensor 10 and can be used as a reference value. R₁ can change over time due to changing external parameters such as temperature, humidity, aging etc. The force sensor 10 can be calibrated against changes of external parameters by shifting or adjusting the measurement curve which depicts the relation between the force F and the resistance R against changes in the first layer resistance R₁ by regularly measuring the value of the first layer resistance R₁. The first layer resistance Riis determined in a step S200 in a state in which no force F is applied to the force sensor 10 using a method for determining a resistance such as described for step S110 in FIG. 7. A determined value for the force F can be corrected by using a shifted or adjusted measurement curve in a step S210.

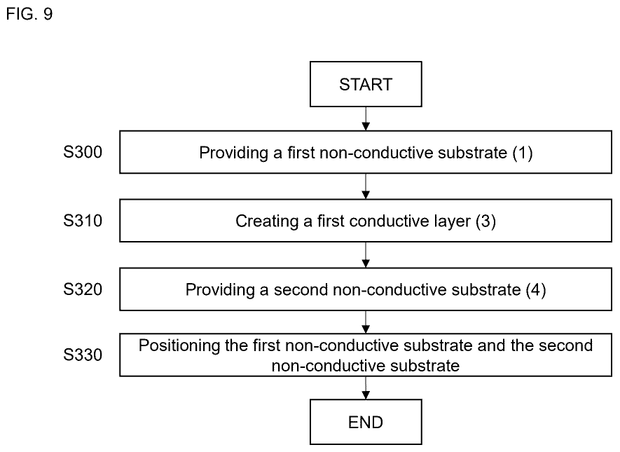

FIG. 9 shows a flow chart describing a method for manufacturing the force sensor 10. A first non-conductive substrate 1 with a first electrode 2a and a second electrode 2b is provided in a step S300. The first electrode 2a and the second electrode 2b are arranged on a surface of the first non-conductive substrate 1. The second electrode 2b is offset to the first electrode 2a. A first conductive layer 3 is created on a surface of the first non-conductive substrate 1 in a step S310 such that the first conductive layer 3 conductively connects the first electrode 2a and the second electrode 2b and a surface 20 of the first conductive layer 3 has a microstructure.

The first conductive layer 3 is created on the first non-conductive substrate 1 and on the first electrode 2a and on the second electrode 2b by using a printing manufacturing process, such as a roll-to-roll process. The material used for printing the first conductive layer 3 contains silver (or other materials such as copper or gold) to provide sufficient electrical conductivity. The surface 20 of the first conductive layer 3 forms a microstructure hat results from the material of the first conductive layer 3 being printed on the first electrode 2a and the second electrode 2b. The microstructure can have a wavelike form (such as shown on FIG. 5). The parameters of the microstructure such as tread depth, shape of the structure, dimensions and regularity can be influenced by the quantity, arrangement, and dimensions of the first electrode 2a and the second electrode 2b as well by the parameters of the printing process used for creating the first conductive layer 3.

This microstructured surface 20 of the first conductive layer 3 can be created using standard available inks and printing processes. No further process steps than printing the first conductive layer 3 onto the first electrode 2a, the second electrode 2b and the first nonconductive substrate 1 are necessary to create the microstructured surface 20.

The first electrode 2a and the second electrode 2b can also be applied to the first non-conductive substrate 1 using a printing process.

A second non-conductive substrate 4 with a second conductive layer 5 is provided in a step S320. The second conductive layer 5 can also be applied to the second non-conductive substrate 5 using a printing process.

The first non-conductive substrate 1 and the second non-conductive substrate 4 are positioned in relation to each other in a step S330, for example by folding a substrate that includes the first non-conductive substrate 1 and the second non-conductive substrate 4 or by laminating the first non-conductive substrate 1 and the second non-conductive substrate 4 on top of each other.

### REFERENCE NUMERALS

1 First non-conductive substrate
2a First electrode
2b Second electrode
3 First conductive layer
4 Second non-conductive substrate
5 Second conductive layer
10 Force sensor
20 Surface
D1 First direction
D2 Second direction
F Force
I Current
R Resistance of the force sensor
R1 First layer resistance
R2 Second layer resistance
Rcon Contact resistance
U Voltage
S100 Applying a force
S110 Determining a resistance
S111 Applying a voltage
S112 Measuring a current
S120 Determining the force
S200 Determining the first layer resistance of the first conductive layer
S210 Correcting a determined value of a force
S300 Providing a first non-conductive substrate
S310 Creating a first conductive layer
S320 Providing a second non-conductive substrate
S330 Positioning the first non-conductive substrate and the second non-conductive substrate

1. A force sensor comprising:
a first non-conductive substrate and a second non-conductive substrate;
a first electrode and a second electrode, the first electrode and the second electrode disposed on the first substrate and offset to each other; and
a first conductive layer, disposed on the first substrate and conductively connecting the first electrode and the second electrode with a first layer resistance (R1); and
a second conductive layer, disposed on the second substrate, the second conductive layer configured to conductively connect the first electrode and the second electrode via the second conductive layer with a second layer resistance (R2) when the first nonconductive substrate and the second non-conductive substrate approach each other.

2. The force sensor according to claim 1, wherein the first conductive layer covers at least a part of the first electrode and at least a part of the second electrode.

3. The force sensor according to claim 1, wherein a surface of the first conductive layer has a microstructure.

4. The force sensor according to claim 1, wherein the first electrode and the second electrode have an interdigital finger structure.

5. The force sensor according to claim 1, wherein the first nonconductive substrate and the second non-conductive substrate are the same substrate.

6. A method for measuring a force (F) with a force sensor, the force sensor comprising a first electrode and a second electrode offset to the first electrode, a first conductive layer conductively connecting the first electrode and the second electrode with a first layer resistance, and a second conductive layer, the method comprising the steps of:
applying the force to the force sensor;
determining a resistance (R) of the force sensor between the first electrode and the second electrode;
determining the force (K) from the resistance (R), the first layer resistance (R1) and the second layer resistance (R2).

7. The method according to claim 6, wherein the step of determining the resistance (R) comprises the steps of:
applying a voltage (U) between the first electrode and the second electrode; and
measuring a current (I) between the first electrode and the second electrode.

8. A method for calibrating the force sensor of claim 1, the method comprising the steps of:
determining the first layer resistance (R1) of the first conductive layer; and
correcting a measurement value of a force (F) applied to the force sensor based on the determined first layer resistance (R1).

9. A method for manufacturing a force sensor, the method comprising the steps of:
providing a first non-conductive substrate with a first electrode and a second electrode offset to the first electrode;
creating a first conductive layer on the first non-conductive substrate, such that
the first conductive layer conductively connects the first electrode and the second electrode; and
a surface of the first conductive layer has a microstructure; and
providing a second non-conductive substrate with a second conductive layer.

10. The method according to claim 9, wherein creating of the first conductive layer comprises a printing process.

11. The method according to claim 9, further comprising the step of positioning the first non-conductive substrate and the second non-conductive substrate.

12. The method according to claim 9, wherein the first electrode and the second electrode are applied to the first non-conductive substrate with a printing process.

13. The method according to claim 9, wherein the second conductive layer is applied to the second non-conductive substrate with a printing process.
